(19) United States
(12) Patent Application Publication
(10) Pub. No.: US 2006/0233247 A1
(43) Pub. Date: Oct. 19, 2006

(54) Storing SVC streams in the AVC file format

(76) Inventors: Mohammed Z. Visharam, Santa Clara, CA (US); Ali Tabatabai, Cupertino, CA (US)

Correspondence Address: O'BANION & RITCHEY LLP/ SONY ELECTRONICS, INC., 400 CAPITOL MALL, SUITE 1550, SACRAMENTO, CA, 95814, US

(21) Appl. No.: 11/318,904

(22) Filed: Dec. 23, 2005

Related U.S. Application Data
(60) Provisional application No. 60/670,893, filed on Apr. 13, 2005.

(51) Int. Cl. H04N 7/12; H04N 11/04; H04B 1/66; H04N 11/02

(52) U.S. Cl. 375/240.12

(57) ABSTRACT

A system and method of coding (encoding and/or decoding) video content to extend file formats for storage. The system and method utilizes the concept to define additional sample group description entries. By way of example the method can comprise the steps of: (1) receiving a file with encoded media data as a scalable video codec stream; (2) extracting information identifying the various spatial resolutions, temporal resolutions, quality resolutions or combinations of spatio-temporal-quality resolutions from the media data; (3) generating new description entries and dependency grouping box; (4) populating boxes with extracted metadata; and (5) incorporating metadata into a file associated with the media data using a specific media file format.

### CROSS-REFERENCE TO RELATED APPLICATIONS

This application claims priority from U.S. provisional application serial No. 60/670,893 filed on Apr. 13, 2005, incorporated herein by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

This invention pertains generally to the storing of video content, and more particularly to support the storage of scalable video codec streams in the AVC file format.

2. Description of Related Art

The communication and storage of digital video content continues to play a key role in a wide-range of applications areas. Numerous coding techniques and variations exist with new ones being developed at a rapid rate. For example, H.264, or MPEG-4 Part 10, is a high compression digital video codec standard written by the ITU-T Video Coding Experts Group (VCEG) together with the ISO/IEC Moving Picture Experts Group (MPEG) in a collective effort partnership often known as the Joint Video Team (JVT). The ITU-T H.264 standard and the ISO/IEC MPEG-4 Part 10 standard (formally, ISO/IEC 14496-10) are technically identical, and the technology is also known as AVC, for Advanced Video Coding.

It should be noted that H.264 is a name related to the ITU-T line of H.26x video standards, while AVC relates to the ISO/IEC MPEG side of the partnership project that completed the work on the standard, after earlier development done in the ITU-T as a project called H.26L. It is usual to call the standard as H.264/AVC (or AVC/H.264 or H.264/MPEG-4 AVC or MPEG-4/H.264 AVC) to emphasize the common heritage. The name H.26L, harkening back to its ITU-T history, is far less common, but still used. Occasionally, it has also been referred to as “the JVT codec” , in reference to the JVT organization that developed it. It should be noted that such partnership and multiple naming is not unprecedented, as the video codec standard known as MPEG-2 also arose from a partnership between MPEG and the ITU-T, and MPEG-2 video is also known in the ITU-T community as H.262.

One of the intents of producing H.264/AVC was in creating a standard that could provide good video quality at bit rates that are substantially lower than those that prior standards would require, such as MPEG-2, H.263, or MPEG-4 Part 2, while maintaining a practical level of complexity.

In many existing video coding formats, the coded stream data includes various kinds of headers containing parameters that control the decoding process. In AVC, on the other hand, much of the information that is needed to decode the video codec data (i.e., VCL data) is decoupled, and grouped into parameter sets. Each parameter set is given an identifier that is subsequently used as a reference from a slice of video. Instead of sending the parameter sets inside (in-band) the stream, they can also be sent outside (out-of-band) the stream. This aspect of the AVC codec in general has provided numerous new functionalities, such as provisions for bit-stream switching within the coding framework, provision to group samples that are related (e.g., based on the concept of sub-sequences, layering, and so forth).

The existing file formats (ISO file format and MP4 file format), did not provide a facility for storing and signaling these new functionalities, and hence there was a need to enhance the storage methods to address the new capabilities provided by emerging video coding standards such as AVC and to address the existing limitations of those storage methods. Consequently, a new extension to the ISO/MP4 file formats emerged which is known as the AVC File Format (ISO/IEC 14496-15, Information Technology—Coding of audio-visual objects—Part 15: AVC File Format).

The existing file formats (ISO/MP4 and AVC) do not provide an easy and clear mechanism to extract the different variations of the spatial, temporal and SNR (quality) layers from the stored media data in the file format. Therefore this information must be extracted by parsing the coded stream, which is an inefficient and slow process. Thus, there is a need to enhance these storage methods to address the new capabilities provided by emerging video coding standards such as SVC and to address the existing limitations of those storage methods

Accordingly, in view of the above shortcomings, it will be recognized that an extension of the existing formats is needed for storing video content coded using the emerging Scalable Video Coding (SVC) standard.

### BRIEF SUMMARY OF THE INVENTION

A system and method are described for extending the current ISO/MP4/AVC File Format to store video content, such as coded using the MPEG-4: Part 10/Amd-1 Scalable Video Codec (SVC) standard whose development is currently under progress in MPEG/ITU-T.

An encoder and/or decoder (i.e., codec) according to the present system utilizes the above concept to define two new Sample Group Description entries. The first one being the Temporal Layer Dependency Description Entry, whose entries would document the various Temporal resolutions (i.e., the TemporalLevelID) that the stream provides, and the second one being the Spatial Layer Dependency Description Entry that would document the various spatial resolutions (i.e., the DependencyID) present in the bitstream.

A new variant of the SampleGroupBox is then defined, called the SVCDependencyGroupingBox. This box is configured for documenting the various spatial, temporal, quality or any combination of spatio-temporal-quality dependencies for all the samples that are present in the bitstream. An aspect of the invention includes two new Sample Group Description Entries coupled with the SVCDependencyGroupingBox, providing a solution that enables the invention to efficiently extract various spatio-temporal and quality layers from the entire bitstream. By parsing these structures, an application can extract/decode various sub-sets of the entire stream.

The invention is amenable to being embodied in a number of ways, including but not limited to the following descriptions.

One implementation of the invention provides a method for supporting the storage of scalable video codec streams in the AVC file format, comprising: (a) receiving a file with encoded media data as a scalable video codec stream during an encoding process; (b) extracting information identifying the various spatial resolutions, temporal resolutions, quality resolutions or spatio-temporal-quality resolutions from the media data; (c) generating new description entries and dependency grouping box; (d) populating boxes with extracted metadata; and (e) incorporating metadata into a file associated with the media data using a specific media file format.

The method can be embodied to incorporate extensions to the ISO, MP4 and AVC file formats to store scalable video content. In one aspect of the invention the video content is MPEG-4 coded. It will be appreciated that the method can also provide for the decoding of a file containing the metadata, or for a system which incorporates both the encoding and decoding, or any combination thereof. By way of example, the decoding can comprise: (a) receiving a file associated with the encoded media data, including metadata identifying the various temporal resolutions, spatial resolutions, quality resolutions or any combination of spatio-temporal-quality resolutions within the media file; and (b) extracting the spatial, temporal, quality or any combination of spatio-temporal-quality resolution information and combining various media samples into packets configured for processing within a media decoder.

By way of example, the method can provide for maintaining a sample group description box configured for retaining information about spatial, temporal, quality or spatio-temporal-quality resolution during an encoding process, or decoding the media file in response to the information retained about spatial, temporal, quality or spatio-temporal-quality resolution. The method can provide for maintaining the information for all the samples present in a bitstream of the media data. In one aspect the grouping box comprises a number of layer entries describing different spatial, temporal, quality or any desired combination of spatial, temporal, and quality (e.g., spatio-temporal-quality) resolutions available in a given track. In one configuration the layer entries can be numbered and ordered hierarchically based on dependency with each other. According to one aspect the spatial resolution information comprises: dependency identification, visual width, and visual height information. According to one aspect the temporal resolution information comprises: temporal level number, temporal frame rate, and dependency count.

According to one aspect the method further comprises maintaining quality level information of the number of quality levels that are represented by the various spatial, temporal, and/or spatio-temporal resolutions.

One implementation of the present invention provides a system for coding media files, comprising: (a) a media coding device configured for receiving media files; (b) a computer processor within the media coding device configured for coding a media file being received; (c) a computer readable media (memory) associated with the computer processor, the memory configured for retaining program code executable as programming on the computer processor; and (d) programming executable on the computer processor to encode media data being received for, (d)(i) performing media encoding in response to any media data received by the media coding device, (d)(ii) generating medadata in response to determining temporal, spatial, and/or spatio-temporal resolutions of the received media, and (d)(iii) incorporating the temporal, spatial, and/or spatio-temporal resolution metadata in an output media file.

It should be appreciated that the method and system of the present invention can be embodied in any computer readable media (e.g., software or firmware), such as program code on a media, and can be distributed separately or with associated processing hardware. It will be understood that the operable software, code, programmed instructions, and the like for implementing the present invention may be stored in any desired form of computer readable storage media such as system memory, removable media, fixed disks, CDs, DVDs, and other forms of storage media configured for the storage of programmatic instructions and/or data.

Described within the teachings of the present invention are a number of inventive aspects, including but not necessarily limited to the following.

In one aspect of the invention an application can extract a particular lower temporal resolution from the original stream for playback on a low power client device whose display has limitations pertaining to temporal rate.

Another aspect of the invention provides for extracting a lower spatial resolution from the original stream either for playback on a low-resolution client device or for streaming over a bandwidth-limited network connection.

A still further aspect of the invention provides for extracting a low-quality stream from the original stream due to limitations in bandwidth or decoding complexity.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1 is a block diagram of a media encoding system according to an embodiment of the present invention.

FIG. 2 is a block diagram of a media decoding system according to an embodiment of the present invention.

FIG. 3 is a block diagram of a suitable computer environment according to one aspect of the present invention.

FIG. 4 is a flowchart of an encoding process according to an embodiment of the present invention.

FIG. 5 is a flowchart of a decoding process according to an embodiment of the present invention.

FIG. 6 is a data structure hierarchy of SVC NAL units groupings according to an aspect of the present invention, showing spatio-temporal quality dependencies.

### DETAILED DESCRIPTION OF THE INVENTION

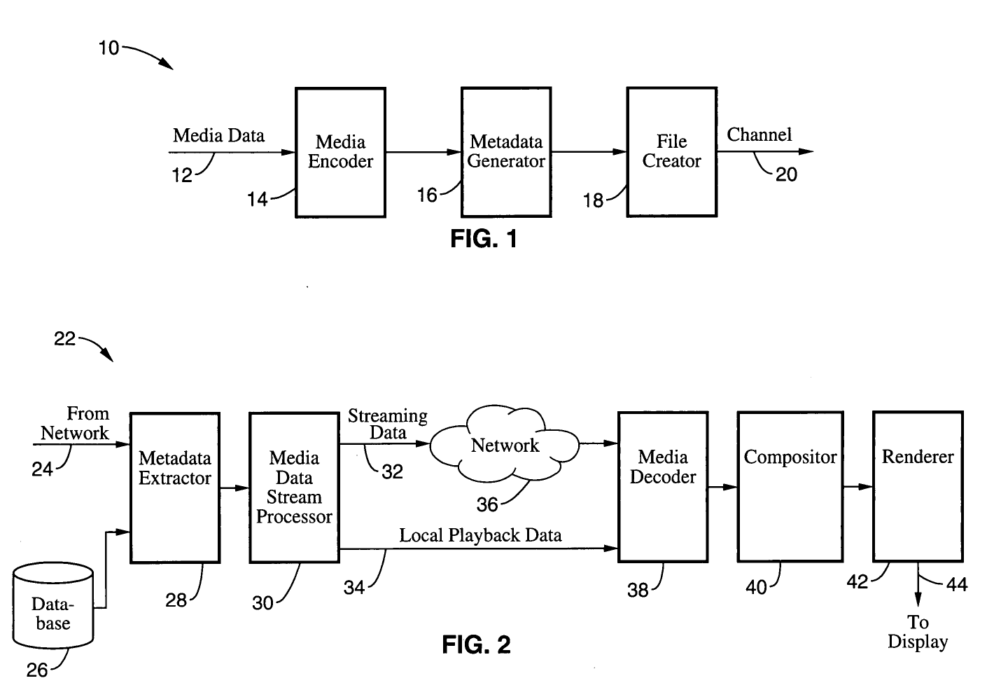

Referring more specifically to the drawings, for illustrative purposes the present invention is embodied in the system and method generally shown in FIG. 1 through FIG. 6. It will be appreciated that the system may vary as to configuration and as to details of the parts, and that the method may vary as to the specific steps and sequence, without departing from the basic concepts as disclosed herein.

1. Introduction.

The present invention provides a possible solution for storing SVC video streams within the ISO/AVC framework. Sample group description entries are provided for easy extraction of various temporal and spatial resolutions. In addition, a variation of spatio-temporal-quality dependencies are provided for all samples in a sample group box generally referred to herein as SVCDependencyGroupingBox.

One of the well known file formats for encoding and storing audiovisual data is the QuickTime™ file format developed by Apple Computer® Inc. The QuickTime file format was used as the starting point for creating the International Organization for Standardization (ISO) Multimedia file format, ISO/IEC 14496-12, Information Technology—Coding of audio-visual objects—Part 12: ISO Media File Format (also known as the ISO file format), which was, in turn, used as a template for two standard file formats: (1) an MPEG-4 file format developed by the Moving Picture Experts Group, known as MP4 (ISO/IEC 14496-14, Information Technology—Coding of audio-visual objects—Part 14: MP4 File Format); and (2) a file format for JPEG 2000 (ISO/IEC 15444-1), developed by Joint Photographic Experts Group (JPEG).

A number of coding techniques and variations exist, for example, H.264, or MPEG-4 Part 10, is a high compression digital video codec standard written by the ITU-T Video Coding Experts Group (VCEG) and together with the ISO/IEC Moving Picture Experts Group (MPEG) is a collective effort partnership often known as the Joint Video Team (JVT). The ITU-T H.264 standard and the ISO/IEC MPEG-4 Part 10 standard (formally, ISO/IEC 14496-10) are technically the same, and the technology is also known as AVC, for Advanced Video Coding.

The use of a network abstraction layer (NAL) definition allows the same video syntax to be used in many network environments, including features such as sequence parameter sets (SPSs) and picture parameter sets (PPSs) that provide more robustness and flexibility than provided in prior designs.

The ISO media file format is composed of object-oriented structures referred to as boxes (also referred to as atoms or objects). The two important top-level boxes contain either media data or metadata. Most boxes describe a hierarchy of metadata providing declarative, structural and temporal information about the actual media data. This collection of boxes is contained in a box known as the movie box. The media data itself may be located in media data boxes or externally. The collective hierarchy of metadata boxes providing information about a particular media data are known as tracks.

The primary metadata is the movie object. The movie box includes track boxes, which describe temporally presented media data. The media data for a track can be of various types (e.g., video data, audio data, etc.). Each track is further divided into samples (also known as access units or pictures). A sample represents a unit of media data at a particular point in time. Sample metadata is contained in a set of sample boxes. Each track box contains a sample table box metadata box, which contains boxes that provide the time for each sample, its size in bytes, and so forth. A sample is the smallest data entity which can represent timing, location, and other metadata information. Samples may be grouped into chunks that include sets of consecutive samples. Chunks can be of different sizes and include samples of different sizes.

Currently the JVT group is working on a new codec known as the Scalable Video Codec (SVC), which would provide an extension to the existing AVC codec. Work on SVC started independently in the MPEG domain initially as a part of the MPEG-21 standard in 2003. But during its development in 2004, it was merged with the activities of the JVT group with a focus towards developing coding technology that would be backwards compatible with the existing AVC codec. As such it currently is jointly developed by the JVT group in MPEG and ITU-T. The goal of the Scalable Video Codec (SVC) activity is to address the need and provide for scalability in the Spatial, Temporal and Quality (SNR) levels.

The current WD 1.0 of Scalable Video Codec (SVC) uses a container defined as the ‘decodability_dependency_information’ within each NAL unit, that specifies the dependency information for each NAL unit. This syntax element is only a container for the terms DependencyID, TemporalLevelID and QualityLevel that can be extracted from the field ‘decodability_dependency_information’. These three variables control the different scalability directions, namely the temporal, spatial and SNR levels. TemporalLevelID controls the inter-picture scalability (i.e., temporal scalability). To decode a given picture with a TemporalLevelID=n you would need all pictures with a TemporalLevelID≦n. DependencyID controls the different “layers” of spatial and/or quality resolution for a given picture. To decode a slice/picture with DependencyID=n you would need all NAL units of the same picture with DependencyID<=n. The most “common” usage of DependencyID is to control the spatial scalability. However two “layers” with different DependencyID values can also have the same resolution (and in this case DependencyID corresponds to coarse grain quality scalability). The quality parameter QualityLevel controls quality scalability. To decode a slice/picture with QualityLevel=n you need all NAL of the same picture with QualityLevel<=n. The most “common” usage of QualityLevel is to control Fine Grain Scalability.

FIG. 1 illustrates by way of example embodiment an overview of an inventive encoding system 10, which receives media data 12 and comprises a media encoder 14, a metadata generator 16 and a file creator 18, prior to outputting a channel 20. Media encoder 14 receives media data that may include video data (e.g., video objects created from a natural source video scene and other external video objects), audio data (e.g., audio objects created from a natural source audio scene and other external audio objects), synthetic objects, or any combination of the above. Media encoder 14 may comprise any desired number of individual encoders or include sub-encoders to process various types of media data. Media encoder 14 codes the media data and passes it to metadata generator 16.

Metadata generator 16 generates metadata that provides information about the media data according to a media file format. The media file format may be derived from the ISO media file format (or any of its derivatives such as MPEG-4, JPEG 2000, etc.), QuickTime or any other media file format, and also includes some additional data structures. According to the present invention, the metadata generator is configured to generate information about the various temporal and/or spatial resolutions of the media (stream). The metadata information is placed in a variant of the sample group box.

The system may include additional data structures which are defined to store metadata pertaining to sub-samples within the media data. In one optional system aspect, additional data structures are defined to store metadata linking portions of media data (e.g., samples or sub-samples) to corresponding parameter sets which include decoding information that has been traditionally stored in the media data. In another optional system aspect, additional data structures are defined to store metadata pertaining to various groups of samples within the metadata that are created based on inter-dependencies of the samples in the media data. In still another optional system aspect, an additional data structure is defined to store metadata pertaining to switch sample sets associated with the media data. A switch sample set refers to a set of samples that have identical decoding values but may depend on different samples. In yet other optional system aspects, various combinations of the additional data structures are defined in the file format being used. These additional data structures and their functionality will be described in greater detail below.

File creator 18 stores the metadata in a file whose structure is defined by the media file format. In one optional system aspect, the file contains both the coded media data and metadata pertaining to that media data. Alternatively, the coded media data is included partially or entirely in a separate file and is linked to the metadata by references contained in the metadata file (e.g., via URLs). The file created by file creator 18 is available on a channel 20 for storage or transmission.

FIG. 2 illustrates an embodiment of a decoding system 22 which is shown receiving network data 24 and database data 26 within a metadata extractor 28. The blocks include metadata extractor 28, a media data stream processor 30, from which streaming data 32 and local playback data 34 are generated. Streaming data from a network 36 and local playback data are received at a media decoder 38, a compositor 40 and a renderer 42, the output signal 42 of which is adapted for use by a display.

The decoding system 22 may reside on a client device and be used for local playback. Alternatively, the decoding system 22 may be used for streaming data and have a server portion and a client portion communicating with each other over a network (e.g., Internet) 36. The server portion may include the metadata extractor 28 and the media data stream processor 30.

The client portion may include the media decoder 38, the compositor 40 and the renderer 42.

The metadata extractor 28 is responsible for extracting metadata from a file stored in a database 26 or received over a network 24, such as from encoding system 10. The file may or may not include media data associated with the metadata being extracted. The metadata extracted from the file includes one or more of the additional data structures described above.

The extracted metadata is passed to the media data stream processor 30 which also receives the associated coded media data. The media data stream processor 30 utilizes the metadata to form a media data stream to be sent to the media decoder 38.

According to one implementation, the media data stream processor 30 uses metadata pertaining to sub-samples to locate sub-samples in the media data (i.e., for packetization). In one implementation of the system, the media data stream processor 30 uses metadata pertaining to parameter sets to link portions of the media data to its corresponding parameter sets. In yet another implementation, the media data stream processor 30 uses metadata defining various groups of samples within the metadata to access samples in a certain group, by way of example to provide scalability by dropping a group containing samples on which no other samples depend to lower the transmitted bit rate in response to transmission conditions. In still another implementation, the media data stream processor 30 uses metadata defining switch sample sets to locate a switch sample that has the same decoding value as the sample it is supposed to switch to but does not depend on the samples on which this resultant sample would depend on, for example to allow switching to a stream with a different bit-rate at a P-frame or B-frame.

Once the media data stream is formed, it is sent for decoding to the media decoder 38. The stream is sent either directly, such as for local playback, or over a network 36 such as for streaming data. The compositor 40 receives the output of media decoder 38 and composes a scene which is then rendered by the renderer 42 with output 44 configured for being displayed on a user display device.

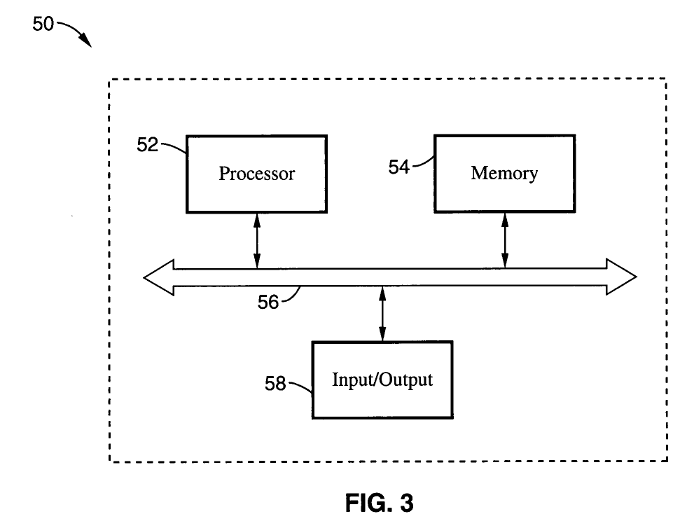

FIG. 3 is an overview of computer hardware and other operating components suitable for implementing the invention, but is not intended to limit the applicable environments on which the invention may be practiced. Computer system 50 is a suitable platform for use as metadata generator 16 and/or file creator 18 depicted in FIG. 1, or as metadata extractor 28 and/or media data stream processor 30 as depicted in FIG. 2.

The computer system 50 includes a processor 52, memory 54 and input/output capability 58 coupled to a system bus 56. Memory 54 is configured to store instructions which, when executed by processor 52 perform the methods described herein. It should be appreciated that memory 54 may comprise any form of data storage capable of storing programming and/or data. Input/output 58 also encompasses various types of computer-readable media, including any type of storage device that is accessible by processor 52. One of ordinary skill in the art will immediately recognize that the term “computer-readable medium/media” further encompasses a carrier wave that encodes a data signal. It will also be appreciated that the system 50 is preferably controlled by operating system software executing in memory 54. Input/output and related media 58 store the computer-executable instructions for the operating system and methods of the present invention. Each of the metadata generator 16, the file creator 18 the metadata extractor 28 and the media data stream processor 30 that are shown in FIGS. 1 and 2 may be a separate component coupled to the processor 52, or may be embodied in computer-executable instructions executed by processor 52.

In one system implementation the computer system 50 may be part of, or coupled to, an ISP (Internet Service Provider) through input/output 58 to transmit or receive media data over the Internet. It should be appreciated that the present invention is not limited to Internet access and Internet web-based sites, for example directly coupled and private networks are also contemplated.

It will be appreciated that computer system 50 is one example of many possible computer systems which may be implemented according to any desired architecture. A typical computer system will usually include at least a processor, memory, and a bus coupling the memory to the processor. One of ordinary skill in the art will immediately appreciate that the invention can be practiced with other computer system configurations, including multiprocessor systems, minicomputers, mainframe computers, and the like. The invention can also be practiced in distributed computing environments where tasks are performed by remote processing devices that are linked through a communications network.

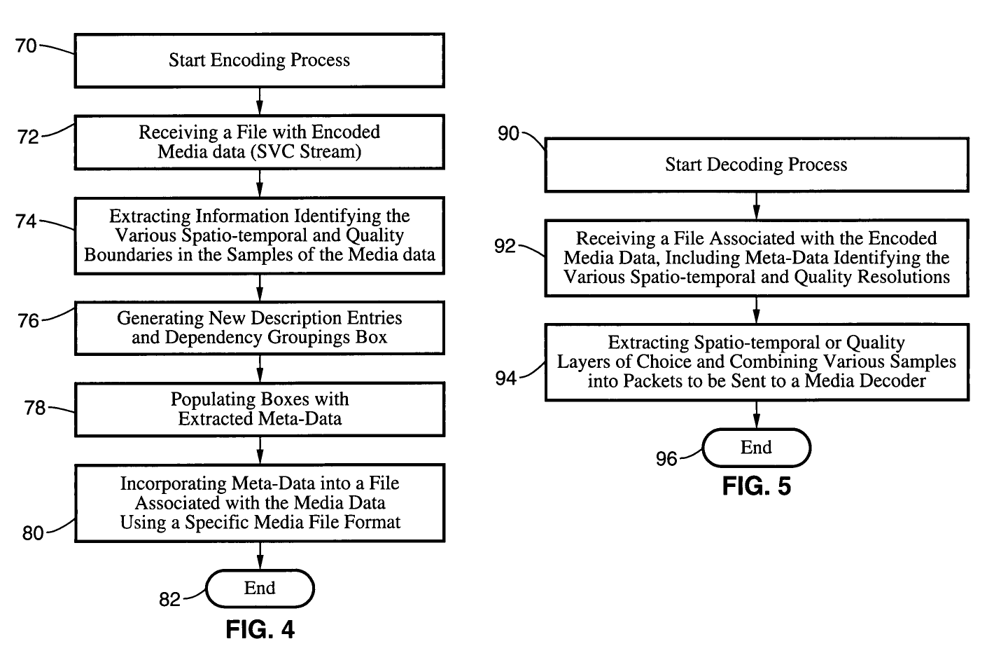

FIG. 4 and FIG. 5 describe the steps in the encoding and decoding process according to one system implementation. In FIG. 4 an encoding process is depicted in which a coded SVC stream is received from which relevant metadata is extracted and stored in an ISO/AVC File Format.

The start of the encoding process is represented by block 70 and a file is received according to block 72 which is encoded with media data (SVC Stream). In block 74 information is extracted which identifies the various spatio-temporal and quality boundaries in the samples of the media data. New description entries and a dependency grouping box are generated as per block 76. Populating of boxes with the extracted metadata is shown in block 78. In block 80 metadata is incorporated into a file associated with the media data using a specific media file format, and the process terminates at block 82.

The start of the decoding process is represented by block 90 and a file associated with the encoded media data is received as per block 92, which includes the metadata identifying the various spatio-temporal and quality resolutions. In block 94 extracting of the spatial/temporal/or quality layers of choice takes place and the combining of various samples into packets to be sent to a media decoder, wherein the process terminates at block 96.

Temporal Layer Dependency Description Entry.

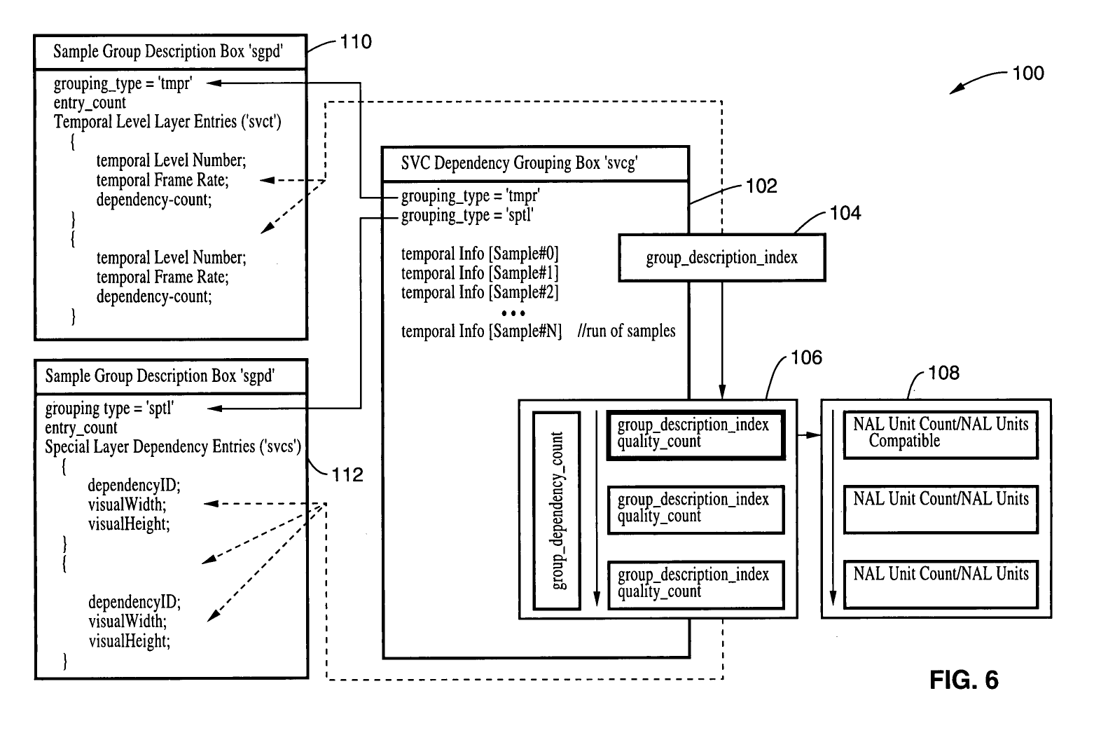

FIG. 6 illustrates by way of example the grouping 100 of SVC NAL units in terms of spatio-temporal-quality dependencies. A definition of the temporal layer dependency description entry exemplified herein with grouping Box ‘svcg’ 102. A group description entry 104 is shown associating sample group description boxes 110, 112 with group count blocks with Box Type: ‘svct’ 106, 108. Group description boxes have container: Sample Group Description Box (‘sgpd’) 110, 112; as being mandatory (Mandatory: Yes), and being single (Quantity: One).

The temporal layer group description entry describes and documents the various possible temporal resolutions that are present for all the samples in a video track. This table of entries, documenting the various temporal levels is a very compact representation in terms of size.

The temporal levels are numbered using non-negative integers and are derived from a temporal level identifier, such as TemporalLevelID field as exemplified herein, present in the syntax element, such as decodability_dependency_information, within SVC NAL units. Temporal Levels are ordered hierarchically based on their dependency on each other. A temporal level having a larger number is at a higher level than one having a smaller number thereby providing a higher temporal rate. The lowest level is numbered as zero and other levels are given consecutive numbers in increasing order. In other words, temporal level 0 is independently decodable providing the lowest temporal rate, and to decode pictures from temporal level 1, pictures from temporal level 0 maybe needed.

The grouping type for this instance of the SampleGroupDescriptionBox is ‘tmpr’. It will be used to link this Box to the SVCDependencyGroupingBox to be defined later.

Temporal Layer Description Syntax Example.

```
class SVCTemporalLayerDependencyDescriptionEntry( ) extends
VisualsampleGroupEntry
(‘svct’) {
    unsigned int (8) temporalLevelNumber;
    unsigned int(8) temporalFrameRate;
    unsigned int(8) dependencyCount;
    unsigned int (8) accurateStatisticsFlag;
    unsigned int (16) avgBitRate;
}
```

Temporal Layer Description Semantics Example.

The following parameters and/or variables are provided by way of example for practicing the invention. It should be appreciated that the names of the data elements/structures are subject to change without changing the underlying concepts.

Variable temporalLevelNumber takes the value of the TemporalLevelID syntax element that is present in the decodability dependency information field within an SVC NAL unit. This non-negative integer variable indicates the temporal level that the sample would provide with respect to time. The lowest temporal rate being numbered as zero and all enhancement layers in the temporal direction being numbered as one or higher. This field takes a default value of zero, when the decodability_dependency_information field within a NAL unit is absent as would be the case for AVC NAL units.

Variable temporalFrameRate provides a variable field for the temporal frame rate that is associated with the temporalLevelNumber entry.

Variable dependency_count is a non-negative integer variable that gives the number of dependency levels that are present within a particular temporal sample description. Here dependency level refers to the number of spatial and sometimes quality dependencies that exist within a temporal sample. For example, the first temporal sample could have a dependency structure of 4CIF, CIF and QCIF and the second temporal sample could be only 4CIF and CIF. In such a scenario, the dependency_count would have the value of three for the former and two for the latter.

Variable accurateStatisticsFlag indicates the reliability of the value of the field avgBitRate that follows. A value for accurateStatisticsFlag equal to one indicates that avgBitRate is rounded from statistically correct values. A value for accurateStatisticsFlag equal to 0 is indicative that avgBitRate is an estimate and may deviate somewhat from the correct values.

The parameter defining the average bit rate, such as avgBitRate, describes the average bit rate in units of 1000 bits per second. All NAL units in this and lower levels are taken into account in the calculation. The average bit rate is calculated according to the decoding timestamp. In the following equation B is the number of bits in all NAL units in this and lower temporal levels, t₁ is the decoding timestamp of the first picture in this and lower levels in the presentation order, and t₂ is the decoding timestamp of the latest picture in this and lower levels in the presentation order. Then, avgBitRate is calculated as follows provided that
t₁!=\overline{t₂}:avgBitRate=round(B/((t₂−t₁)*1000))t₂. If t₁=t₂ :avgBitRate=0 ,
which is indicative of an unspecified bit rate.

Spatial Layer Dependency Description Entry.

The definition of the spatial layer dependency description entry is exemplified herein with Box Type: ‘svcs’; Container: Sample Group Description Box (‘sgpd’); as being mandatory (Mandatory: Yes), and being single (Quantity: One).

The spatial layer dependency group entry describes the spatial layer information for all the samples present in a video track. In similar manner to the previously described Temporal Layer Dependency Description Entry, this box also provides a compact representation of the description of the various spatial layers. It is derived from the DependencyID field present in the syntax element decodability dependency information in SVC NAL units.

The various layer entries in the group describe the different spatial resolutions available in a track. Layers are numbered with non-negative integers and ordered hierarchically based on their dependency on each other. A layer having a larger layer number is a higher layer than a layer having a smaller layer number. According to one embodiment, the lowest layer is numbered as zero and other layers are given consecutive numbers in increasing order.

The grouping type for this instance of the SampleGroupDescriptionBox is ‘sptl’, which will be used to link this Box to the SVCDependencyGroupingBox as defined later.

Spatial Layer Dependency Syntax Example.

```
class SVCSpatialLayerDependencyDescriptionEntry( ) extends
VisualSampleGroupEntry (‘svcs’) {
    unsigned int(8) dependencyID;
    unsigned int(16) visualWidth;
    unsigned int(16) visualHeight;
    unsigned int (8) accurateStatisticsFlag;
    unsigned int(I6) avgBitRate;
}
```

Spatial Layer Dependency Semantics Example.

Variable dependencyID takes the value of the DependencyID syntax element that is present in the decodability dependency information field within an SVC NAL unit. The value is a non-negative integer, with the value of zero signaling the NAL units corresponding to the lowest spatial resolution, and all higher values signal enhancement layers that may provide an increase either in spatial resolution and/or quality, such as coarse grain scalability. Its most common use, however, is that of controlling spatial scalability.

Variable visualWidth represents the value of the width of the coded picture in pixels in this layer of the SVC stream described by the above dependencyID.

Variable visualHeight represents a height value of the coded picture in pixels in this layer of the SVC stream described by the above dependencyID.

Variable accurateStatisticsFlag indicates the reliability of the value of avgBitRate that follows. An accurateStatisticsFlag value equal to one indicates that avgBitRate is rounded from statistically correct values, while a value of zero indicates that avgBitRate is an estimate and may deviate somewhat from the correct values.

The value of avgBitRate represents the average bit rate in units of 1000 bits per second. All NAL units in this and lower layers are taken into account in the calculation. The average bit rate is calculated according to the decoding timestamp. In the following relation, B is the number of bits in all NAL units in this and lower dependency layers. Value t₁ is the decoding timestamp of the first picture in this and lower layers in the presentation order, and is the decoding timestamp of the latest picture in this and lower layers in the presentation order. Then, avgBitRate is calculated as follows provided that t₁!=\overline{t}₂:avgBitRate=round (B/((t₂−t₁)*1000)) t₂. If t₁=t₂: avgBitRate=0, If avgBitRate shall be 0. A zero value indicates an unspecified bit rate.

SVC Dependency Grouping Box.

The definition of the temporal layer dependency description entry is exemplified herein with Box Type: ‘svcg’; Container: Sample Table Box (‘stbl’); as being mandatory (Mandatory: Yes), and being single (Quantity: One).

This table is utilized in the bitstream extraction process from the SVC file format depending on the constraints imposed in terms of temporal, spatial and quality requirements. This table provides the grouping and dependency information for each sample in a track, and the associated description information related to that sample.

A group_description_index is used to refer to a particular entry present in the SampleDescriptionBox where the entries describe the characteristics of the group. For this new Box the group_description_index refers to the new temporal layer entries that we have defined earlier. The dependency_count is inferred from the particular temporal layer entry and depending on the count, we have the secondary group_description_entry which refers to the spatial layer entries.

The associated SampleGroupDescription shall indicate the same value for the grouping type. FIG. 1 provides a visual description of referencing for dependencies according to the present invention.

SVC Dependency Grouping Syntax Example.

```
aligned (8) class SVCQualityInfo
{
    unsigned int(8) NalUnit_count;
    if (qualityLevel_count 0) l/when qualityLevel is 0 (default for AVC NAL units)
    unsigned int(8) avcBaseLayerFlag;
{
aligned(s) class SVCSpatialDependencyInfo
{
    unsigned mt (8) skip_offset; /f# of bytes to skip to read the next dependencyInfo unsigned
    int(8) group_description_index; // Context: Refer to ‘sptl’ unsigned mt (8) qualityLevel
    count;
    SVCQualityInf o quality [qualityLevel_count];
}
aligned(s) class SVCTemporalInfo
{
    unsigned int(8) skip offset; //#bytes to skip to read next temporalInfo
    unsigned int(8) group_description_index; // Context: refer to ‘tmpr’
    SVCSpatialDependencyInfo dependency [dependency_count];
}
aligned(8) class SVCDependencyGroupingBox extends FullBox(’svcg’, version = 0, 0)
{
    unsigned int(32) temporal_grouping_type; //Temporal Grouping Type ‘tmpr’unsigned
    int(32) spatial_grouping_type; //Spatial Grouping Type ‘spt1’
    unsigned int sample count; // calculated from the sample to chunk box SVCTemporalInfo
    temporalInfo [sample_count];
}
```

SVC Dependency Grouping Semantics Example.

Variable temporal_grouping_type is an integer that identifies the type of sample grouping used to indicate temporal scalability and links it to its associated sample group description table with the same value for grouping type. It takes the value of ‘tmpr’ to link it to the TemporalLayerDependencyDescriptionEntry in the SampleGroupDescriptionBox.

Variable spatial_grouping type is an integer that identifies the type of sample grouping used to indicate the spatial dependency information of each sample and links it to its associated sample group description table with the same value for grouping type. It takes the value of ‘sptl’ to link it to the SpatialLayerDependencyDescriptionEntry in the Sample GroupDescriptionBox.

Value sample_count denotes the number of samples that are present in the media track, and is an inferred value that can be calculated from the Sample to Chunk Box.

It should be noted that data temporalInfo[sample_count] has been defined in this embodiment such that dependency information is explicitly stated for all the samples present in a track. There may be possibilities to compact this further using the assumption that dependencies hold true across Group Of Pictures (GOP) boundaries, in which case this table can be compactly represented as runs of GOP's.

Value skip_offset is an integer that conveys the number of bytes to skip excluding itself, in order to read the next entry in the array. This skip could either comprise to the next temporalInfo for the following sample or the next dependencyinfo for the same sample. The skip_offset value provides a means for simpler parsing and skipping through the SVCDependencyGroupingBox.

Variable group_description_index is an integer that gives the index of the sample group entry which describes the samples in this group. The index ranges from one to the number of sample group entries in the particular SampleGroupDescriptionBox, or takes the value zero to indicate that this sample is a member of no group of this type.

According to the syntax given above, the group_description_index within the SVCTemporalInfo refers to the entries defined in temporal_grouping_type ‘tmpr’ while the group description_index within the SVCSpatialDependencyInfo refers to the entries defined in the spatial_grouping_type ‘sptl’.

The value of dependency_count is read from the TemporalLayerDependencyDescriptionEntry, and is a non-negative integer that gives the number of spatial dependency levels that are present within a particular sample. To decode a sample with a particular dependency identifier ‘n’, as defined in the SpatialLayerDependencyDescEntry, you would need all NAL units of the sample to have a dependencyID<=‘n’. The number of lower layers that are needed is thus provided by the field dependency_count.

Variable qualityLevel_count is a non-negative integer that describes the number of quality levels that are present within a particular grouping of SVCDependencyInfo. To decode a sample with a particular quality level ‘n’, all NAL units of the sample would be needed with quality level<=‘n’ having the same dependencyID and all NAL units from the layers having lower dependencyID values.

Variable NalUnit_count is an integer that describes the number of NAL units in a sample or access unit that belong to a particular quality level. The number of quality levels present in a sample is indicated by the field qualityLevel_count in SVCSpatialDependencyInfo. To decode a sample with a particular quality level ‘n’, all NAL units of the sample would be needed with quality level<‘n’.

Binary flag avcBaseLayerFlag indicates the existence of NAL units at the lowest spatial layer that are conforming to the MPEG-4: Part 10 AVC specification, when in a true state. This flag is present only when the quality level is zero, since for AVC NAL units’ decodability_dependency_information is inferred to be zero.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A method for supporting the storage of scalable video codec streams in the AVC file format, comprising:
receiving a file with encoded media data as a scalable video codec stream during an encoding process;
extracting information identifying the various spatial resolutions, temporal resolutions, quality resolutions or spatio-temporal-quality resolutions from said media data;
generating new description entries and dependency grouping box;
populating boxes with extracted metadata; and
incorporating metadata into a file associated with the media data using a specific media file format.

2. A method as recited in claim 1, wherein said method comprises incorporating extensions to the ISO, MP4 and AVC file formats to store scalable video content.

3. A method as recited in claim 1, wherein said video content is MPEG-4 coded.

4. A method as recited in claim 1, further comprising decoding of a file containing said metadata.

5. A method as recited in claim 4, wherein said decoding comprises:
receiving a file associated with the encoded media data, including metadata identifying the various temporal resolutions, spatial resolutions, quality resolutions or spatio-temporal-quality resolutions within the media file; and
extracting the spatial, temporal, quality or spatio-temporal-quality resolution information and combining various media samples into packets configured for processing within a media decoder.

6. A method as recited in claim 1, further comprising maintaining a sample group description box configured for retaining information about spatial, temporal, quality or spatio-temporal-quality resolution during an encoding process, or decoding the media file in response to said information retained about spatial, temporal, quality or spatio-temporal-quality resolution.

7. A method as recited in claim 6, wherein said information is maintained for all the samples present in a bitstream of said media data.

8. A method as recited in claim 1, wherein said grouping box comprises a number of layer entries describing different spatial, temporal, quality or spatio-temporal-quality resolutions available in a given track.

9. A method as recited in claim 8, wherein said layer entries are numbered and ordered hierarchically based on dependency with each other.

10. A method as recited in claim 8, wherein said spatial resolution information comprises: dependency identification, visual width, and visual height.

11. A method as recited in claim 8, wherein said temporal resolution information comprises: temporal level number, temporal frame rate, and dependency count.

12. A method as recited in claim 1, further comprising maintaining quality level information of the number of quality levels that are represented by the various spatial, temporal, or spatio-temporal resolutions.

13. A system for coding media files, comprising:
a media coding device configured for receiving media files;
a computer processor within said media coding device configured for coding a media file being received;
memory associated with said computer processor, said memory configured for retaining program code executable as programming on said computer processor; and
programming executable on said computer processor to encode media data being received for,
performing media encoding in response to any media data received by said media coding device,
generating metadata in response to determining temporal, spatial, or spatio-temporal resolutions of the received media, and
incorporating said temporal, spatial, or spatio-temporal resolution metadata in an output media file.

14. A system as recited in claim 13, wherein said system is configured for incorporating extensions to the ISO, MP4 and AVC file formats to store scalable video content.

15. A system as recited in claim 13, wherein said video content is MPEG-4 coded.

16. A system as recited in claim 13, further comprising programming configured for decoding of a file containing said metadata.

17. A system as recited in claim 16, wherein said programming configured for decoding comprises:
receiving a file associated with the encoded media data, including metadata identifying the various temporal resolutions, spatial resolutions, quality resolutions or spatio-temporal-quality resolutions within the media file; and
extracting the spatial, temporal, quality or spatio-temporal-quality resolution information and combining various media samples into packets configured for processing within a media decoder.

18. A system as recited in claim 13, further comprising programming for maintaining a sample group description box configured for retaining information about spatial, temporal, quality or spatio-temporal-quality resolution during an encoding process, or decoding the media file in response to said information retained about spatial, temporal, quality or spatio-temporal-quality resolution.

19. A system as recited in claim 13:
wherein said grouping box comprises a number of layer entries describing different spatial, temporal, quality or spatio-temporal-quality resolutions available in a given track; and
wherein said layer entries are numbered and ordered hierarchically based on dependency with each other.

20. A media that is computer readable and includes a computer program which, when executed by a controller for a video device capable of receiving video streams over a network causes the controller to perform the steps comprising:
receiving a media file;
performing media encoding in response to any media data being received from said media file;
generating medadata in response to determining temporal, spatial, or spatio-temporal resolutions of the received media; and
incorporating said temporal, spatial, quality, or combinations of spatial, temporal, and quality resolution metadata in an output media file.
